(19) United States
(12) Patent Application Publication
(10) Pub. No.: US 2024/0391778 A1
(43) Pub. Date: Nov. 28, 2024

(54) MODIFIED IRON PHOSPHATE PRECURSOR, AND MODIFIED LITHIUM IRON PHOSPHATE AND PREPARATION METHOD THEREFOR

(71) Applicants: GUANGDONG BRUNP RECYCLING TECHNOLOGY CO., LTD., Foshan, Guangdong (CN); HUNAN BRUNP RECYCLING TECHNOLOGY CO., LTD., Changsha, Hunan (CN)

(72) Inventors: Aixia Li, Foshan, Guangdong (CN); Haijun Yu, Foshan, Guangdong (CN); Changdong Li, Foshan, Guangdong (CN); Yinghao Xie, Foshan, Guangdong (CN)

(21) Appl. No.: 18/686,878

(22) PCT Filed: Mar. 20, 2023
(86) PCT No.: PCT/CN2023/082552

§ 371 Date: Feb. 27, 2024

(30) Foreign Application Priority Data
May 26, 2022 (CN) 202210581979.0

(51) Int. Cl. C01B 25/45; C01B 25/37; H01M 4/58; H01M 10/0525

(52) U.S. Cl. CPC C01B 25/45; C01B 25/375; H01M 4/5825; H01M 10/0525; C01P 2004/03; C01P 2006/40

(57) ABSTRACT

Disclosed in the present invention are a modified iron phosphate precursor, and modified lithium iron phosphate and a preparation method therefor. The modified iron phosphate precursor is prepared by dissolving a soluble ferric salt in a niobium diselenide suspension and then reacting with a phosphoric acid source. The modified iron phosphate precursor can effectively adsorb a lithium source, thereby significantly improving the conductivity of lithium iron phosphate.

### FIELD

The present disclosure belongs to the technical field of battery materials, and in particular relates to a modified iron phosphate precursor, a modified lithium iron phosphate and a preparation method therefor.

### BACKGROUND

Energy shortage and environmental problems are becoming more and more serious. The fossil energy used at this stage will also be used up in the future. To maintain a sustainable development of human society, energy and environment are two serious issues that must be faced in the 21st century. The development of clean and renewable energy is one of the most decisive technologies in the future world economy. As a high-performance secondary green battery, a lithium-ion battery has advantages such as high voltage, high energy density, low self-discharge rate, wide temperature range for use, long cycle life, environmental friendliness, no memory effect, and ability of charging and discharging with high current, so that it is the most potential battery as a power source in the coming years. However, one of the bottlenecks restricting the large-scale industrialization of lithium-ion batteries is the cathode material. Under the premise that lithium-ion batteries are required to have the above-described stability, price and resource issues are also important factors that cannot be ignored.

Lithium iron phosphate, which is an electrode material for lithium-ion batteries and has the chemical formula of LifePO₄ (LFP for short), is mainly used in various lithium-ion batteries. Due to the advantages of low price, no pollution, huge resources, good thermal stability, etc., lithium iron phosphate has become one of the most potential cathode materials at present, and is also the focus of research, production and development in the field of energy-storage lithium-ion batteries.

However, due to the limitation of the structure of lithium iron phosphate itself, the conductivity of lithium iron phosphate as the cathode material in lithium-ion batteries is poor, which greatly limits the application of lithium iron phosphate.

### SUMMARY

The present disclosure aims to solve at least one of the technical problems existing in the prior art. For this reason, the present disclosure provides a modified iron phosphate precursor, a modified lithium iron phosphate and a preparation method therefor. The modified iron phosphate precursor provided by the present disclosure can effectively absorb a lithium source, thereby significantly improving the conductivity of lithium iron phosphate.

In order to solve the above-mentioned technical problems, the present disclosure provides the following technical solutions.

In a first aspect, a modified iron phosphate precursor is provided. The modified iron phosphate precursor is prepared by dissolving a soluble ferric salt in a niobium diselenide suspension and reacting the resulting mixture with a phosphoric acid source.

In the niobium diselenide suspension of the present disclosure, niobium diselenide can be uniformly and stably dispersed in the suspension; specifically, a dispersant or a dispersion liquid can be added during the preparation of the suspension to stably suspend niobium diselenide.

In the present disclosure, the soluble ferric salt is a ferric salt commonly used in the art, preferably at least one of ferric sulfate and ferric nitrate; and the phosphoric acid source is at least one of phosphoric acid and ammonium phosphate.

Preferably, after adding the phosphoric acid source, the pH of the niobium diselenide suspension is 1.8-2.2, preferably 2.0-2.2.

Preferably, after adding the phosphoric acid source, the resulting mixture is heated up to 60-80° C. to react for 2-4 h; preferably, heated up to 70-80° C. to react for 2-3 h.

In the present disclosure, firstly ferric ions are distributed uniformly in the dispersion system of niobium diselenide, and then a phosphoric acid source is added thereto to synthesize an iron phosphate precursor in situ, so that an iron phosphate uniformly doped with niobium diselenide can be obtained. Due to the metallic nature of niobium diselenide, it has excellent superconductivity, and its resistivity is about 3.5×10⁻⁴ Ω·cm. Doping niobium diselenide into lithium iron phosphate in an amount according to the present disclosure can significantly improve the conductivity of lithium iron phosphate, so that the resistivity of lithium iron phosphate is 186 Ω·m or less, while the structural stability of lithium iron phosphate would not be affected.

Further, in the modified iron phosphate precursor, a molar ratio of the soluble ferric salt to niobium diselenide is 1:0.05-0.15, preferably 1:0.1-0.15;

A molar ratio of phosphorus element in the phosphoric acid source to iron element in the soluble ferric salt is 1.4-1.6:1, preferably 1.5-1.6:1.

Further, the niobium diselenide suspension is prepared by dispersing niobium diselenide in a dispersion liquid.

In the preparation process of the niobium diselenide suspension, methods such as stirring and wetting and/or ultrasonication can be used to speed up the dissolution of the niobium diselenide or make niobium diselenide be fully dissolved.

Preferably, in the present disclosure, the niobium diselenide suspension is obtained by adding the niobium diselenide to a dispersion liquid, and stirring and wetting the resulting mixture before ultrasonically dispersing.

The dispersion liquid is an aqueous solution of polyvinylpyrrolidone; preferably, the concentration of polyvinylpyrrolidone in the dispersion liquid is 0.4 wt %-1 wt %, preferably 0.8 wt %-1 wt %.

The solid content of the niobium diselenide suspension is 0.1%-0.5%; preferably 0.3%-0.5%.

Preferably, the stirring is conducted at a rotational speed of 100-200 rpm for 10-15 min, and the ultrasonic dispersion is conducted at 15-20 KHz for 10-20 min.

More preferably, the stirring is conducted at a rotational speed of 150-200 rpm for 10-12 min, and the ultrasonic dispersion is conducted at 16-20 KHz for 10-15 minutes.

In a second aspect, a modified lithium iron phosphate is provided, wherein the modified lithium iron phosphate comprises a lithium source and the modified iron phosphate precursor according to the first aspect.

Lithium in lithium carbonate will be intercalated into a lattice of the iron phosphate to form a modified lithium iron phosphate.

In the present disclosure, since the diffusion barrier of niobium diselenide to lithium is small, lithium can be adsorbed on the surface of niobium diselenide, so that the amount of lithium intercalated in the cathode material can be increased, and the effect of lithium pre-supplementation can be realized, thereby realizing lithium pre-supplementation during the synthesis process of the cathode material. Moreover, an excess amount of lithium is stored in the cathode material, the excess amount of lithium can be released during the initial charging process, and lithium ions deintercalated from the cathode can be retained to the greatest extent, so as to achieve the purpose of improving the initial efficiency.

Further, the lithium source is lithium carbonate, lithium hydroxide, lithium acetate or lithium bromide; preferably lithium hydroxide or lithium carbonate.

In a third aspect, a method for preparing the modified lithium iron phosphate according to the second aspect is provided, the method comprising the following steps:
mixing a lithium source, a carbon source and the modified iron phosphate precursor in a protective atmosphere, and sintering the resulting mixture to obtain the modified lithium iron phosphate.

In the present disclosure, the protective atmosphere is a nitrogen atmosphere or an argon atmosphere.

Further, a molar ratio of the modified iron phosphate precursor to the lithium source to the carbon source is 1:1.1-1.2:0.1-0.3, preferably 1:1.1-1.2:0.2-0.3.

Further, the carbon source is at least one of glucose, lactose and sucrose; a temperature for the sintering is 550-650° C., preferably 600-650° C.; and the sintering is conducted for 6-8 h, preferably 6-7 h.

As a preferred technical solution, the method for preparing the modified lithium iron phosphate of the present disclosure comprises the following steps:

### S1. Preparation of a Niobium Diselenide Suspension:

Adding niobium diselenide into a dispersion liquid, stirring and wetting and ultrasonically dispersing the resulting mixture uniformly to obtain a niobium diselenide suspension with a solid content of 0.1%-0.5%, wherein the dispersion liquid is a deionized aqueous solution of polyvinylpyrrolidone, and a concentration of polyvinylpyrrolidone is 0.4 wt %-1 wt %;

### S2. Preparation of a Modified Iron Phosphate Precursor:

Adding a soluble ferric salt into the niobium diselenide suspension of step S1, stirring the mixture for dissolution, and adding a phosphoric acid source while stirring, controlling the resulting mixture at a pH of 1.8-2.2, and heating up the resulting mixture to 60-80° C. to react for 2-4 h to synthesize iron phosphate in situ, performing solid-liquid separation to obtain the modified iron phosphate precursor, wherein sodium hydroxide or hydrochloric acid is preferably used to adjust pH in this step; and

### S3. Preparation of Modified Lithium Iron Phosphate:

In a nitrogen atmosphere or an inert atmosphere, mixing the modified iron phosphate precursor of step S2, a lithium source and a carbon source, and sintering the resulting mixture to obtain the modified lithium iron phosphate, wherein the inert atmosphere is preferably an argon atmosphere.

In a fourth aspect, a lithium battery is provided, comprising the modified lithium iron phosphate according to the second aspect.

Compared with the prior art, the present disclosure at least has the following beneficial effects.

(1) In the method for preparing modified lithium iron phosphate of the present disclosure, ferric ions are uniformly distributed in the dispersion system of niobium diselenide first, and then added with a phosphoric acid source to synthesize an iron phosphate precursor in situ, so that a ferric phosphate uniformly doped with niobium diselenide can be obtained, and a lithium iron phosphate uniformly doped with niobium diselenide is further obtained. Due to the metallic nature of niobium diselenide, it has excellent superconductivity, and the resistivity thereof is about 3.5×10⁻⁴ Ω·cm. Doping niobium diselenide into lithium iron phosphate in an amount according to the present disclosure can significantly improve the conductivity of lithium iron phosphate, so that the resistivity of lithium iron phosphate is 186 Ω·m or less, while the structural stability of lithium iron phosphate would not be affected.

(2) In the method for preparing the modified lithium iron phosphate of the present disclosure, since the diffusion barrier of niobium diselenide to lithium is small, during the sintering process, lithium can be adsorbed on the surface of niobium diselenide, so that the amount of lithium intercalated in the cathode material can be increased, and the effect of lithium pre-supplementation can be realized, thereby realizing lithium pre-supplementation during the synthesis process of the cathode material. Moreover, an excess amount of lithium is stored in the cathode material, the excess amount of lithium can be released during the initial charging process, and the lithium ions deintercalated from the cathode can be retained to the greatest extent, so as to achieve the purpose of improving the initial efficiency.

(3) In the method for preparing the modified lithium iron phosphate of the present disclosure, due to the larger surface energy of niobium diselenide particles, the niobium diselenide particles are prone to agglomeration, so that sedimentation occurs. In the present disclosure, niobium diselenide can be added to the dispersion liquid containing polyvinylpyrrolidone for dispersion. On the one hand, the surface energy of niobium diselenide can be effectively reduced to maintain a stable dispersion state of niobium diselenide. On the other hand, the stability of niobium diselenide in air is poor, but polyvinylpyrrolidone has film-forming properties, which can play a surface encapsulation protection role to niobium diselenide, improving the stability of niobium diselenide, and the polyvinylpyrrolidone can be removed in the later sintering process. Moreover, polyvinylpyrrolidone has reducibility, which can further improve the reduction effect on ferric irons; in addition, polyvinylpyrrolidone can promote the uniform distribution of ferric ions in the dispersion system, thereby improving the doping uniformity of niobium diselenide in the cathode material.

### BRIEF DESCRIPTION OF DRA WINGS

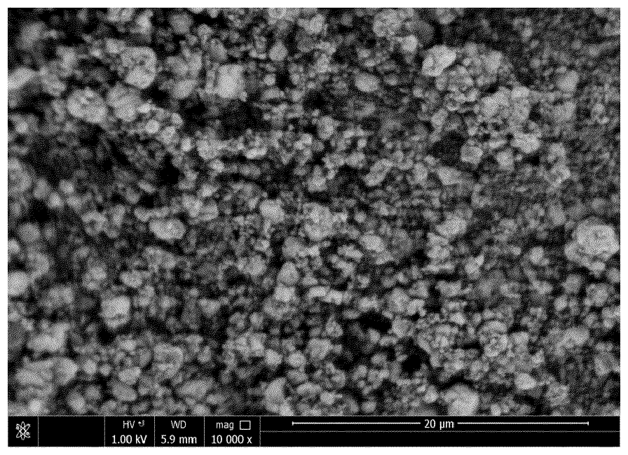

FIG. 1 is a scanning electron microscopy (SEM) image of the modified lithium iron phosphate of Example 1 of the present disclosure.

### DETAILED DESCRIPTION

The present disclosure will be further described below in conjunction with specific examples, wherein the raw materials used in the examples and comparative examples can be commercially available, and the same ones are used in parallel experiments.

### Example 1

The present example provided a modified lithium iron phosphate, and a method for preparing the modified lithium iron phosphate comprised the following steps:

### S1. Preparation of a Niobium Diselenide Suspension:

Niobium diselenide was added into a dispersion liquid, and the resulting mixture was stirred and wetted (stirred at 100 rpm for 15 min) and then ultrasonically dispersed uniformly (ultrasonically dispersed at 15 KHz for 20 min) to obtain a niobium diselenide suspension with a solid content of 0.1%, wherein the dispersion liquid was a deionized aqueous solution of polyvinylpyrrolidone, and the concentration of polyvinylpyrrolidone was 0.4 wt %;

### S2. Preparation of a Modified Iron Phosphate Precursor:

Ferric sulfate was added into the niobium diselenide suspension prepared in step S1, so that a molar ratio of ferric sulfate to niobium diselenide was 1:0.05. The resulting mixture was stirred for dissolution, and added with phosphoric acid while stirring so that a molar ratio of phosphorus:iron=1.4:1. The mixture was controlled at a pH of 1.8 (pH was adjusted with sodium hydroxide or hydrochloric acid), and heated up to 60° C. to react for 4 h, to synthesize the iron phosphate in situ. The obtained product was subjected to solid-liquid separation to obtain the modified iron phosphate precursor; and

### S3. Preparation of Modified Lithium Iron Phosphate:

In a nitrogen atmosphere, the modified iron phosphate precursor of step S2, lithium carbonate and sucrose were mixed, so that a molar ratio of the modified iron phosphate precursor, to lithium carbonate and to sucrose was 1:1.1:0.1. The resulting mixture was sintered at 550° C. for 8 h to obtain the modified lithium iron phosphate.

The SEM image of the appearance of modified lithium iron phosphate particles prepared in Example 1 was shown in FIG. 1.

### Example 2

The present example provided a modified lithium iron phosphate, and a method for preparing the modified lithium iron phosphate comprised the following steps:

### S1. Preparation of a Niobium Diselenide Suspension:

Niobium diselenide was added into a dispersion liquid, and the resulting mixture was stirred and wetted (stirred at 200 rpm for 10 min) and then ultrasonically dispersed uniformly (ultrasonically dispersed at 20 KHz for 10 min) to obtain a niobium diselenide suspension with a solid content of 0.3%, wherein the dispersion liquid was a deionized aqueous solution of polyvinylpyrrolidone, and a concentration of polyvinylpyrrolidone was 0.8 wt %;

### S2. Preparation of a Modified Iron Phosphate Precursor:

Ferric nitrate was added into the niobium diselenide suspension prepared in step S1, so that a molar ratio of ferric nitrate to niobium diselenide was 1:0.1. The resulting mixture was stirred for dissolution, and added with phosphoric acid while stirring so that a molar ratio of phosphorus:iron=1.5:1. The mixture was controlled at a pH of 2.2 (pH was adjusted with sodium hydroxide or hydrochloric acid), and heated up to 70° C. to react for 3 h to synthesize the iron phosphate in situ. The obtained product was subjected to solid-liquid separation to obtain the modified iron phosphate precursor; and

### S3. Preparation of Modified Lithium Iron Phosphate:

In a nitrogen atmosphere, the modified iron phosphate precursor of step S2, lithium carbonate and sucrose were mixed, so that a molar ratio of the modified iron phosphate precursor, to lithium carbonate and to sucrose was 1:1.1:0.2. The resulting mixture was sintered at 650° C. for 6 h to obtain the modified lithium iron phosphate.

### Example 3

The present example provided a modified lithium iron phosphate, and a method for preparing the modified lithium iron phosphate comprised the following steps:

### S1. Preparation of a Niobium Diselenide Suspension:

Niobium diselenide was added into a dispersion liquid, and the resulting mixture was stirred and wetted (stirred at 150 rpm for 12 min) and then ultrasonically dispersed uniformly (ultrasonically dispersed at 16 KHz for 15 min) to obtain a niobium diselenide suspension with a solid content of 0.5%, wherein the dispersion liquid was a deionized aqueous solution of polyvinylpyrrolidone, and a concentration of polyvinylpyrrolidone was 1 wt %;

### S2. Preparation of a Modified Iron Phosphate Precursor:

Ferric sulfate was added into the niobium diselenide suspension prepared in step S1, so that a molar ratio of ferric sulfate to niobium diselenide was 1:0.15. The resulting mixture was stirred for dissolution, and added with ammonium phosphate while stirring so that a molar ratio of phosphorus:iron=1.6:1. The mixture was controlled at a pH of 2.0 (pH was adjusted with sodium hydroxide or hydrochloric acid), and heated up to 80° C. to react for 2 h to synthesize the iron phosphate in situ. The obtained product was subjected to solid-liquid separation to obtain the modified iron phosphate precursor; and

### S3. Preparation of Modified Lithium Iron Phosphate:

In a nitrogen atmosphere, the modified iron phosphate precursor of step S2, lithium carbonate and sucrose were mixed, so that a molar ratio of the modified iron phosphate precursor, to lithium carbonate and to sucrose was 1:1.2:0.3. The resulting mixture was sintered at 650° C. for 6 h to obtain the modified lithium iron phosphate.

### Example 4

The present example provided a modified lithium iron phosphate, and a method for preparing the modified lithium iron phosphate comprised the following steps:

### S1. Preparation of a Niobium Diselenide Suspension:

Niobium diselenide was added into deionized water, and the resulting mixture was stirred and wetted (stirred at 150 rpm for 12 min) and then ultrasonically dispersed uniformly (ultrasonically dispersed at 16 KHz for 15 min) to obtain a niobium diselenide suspension with a solid content of 0.5%;

### S2. Preparation of a Modified Iron Phosphate Precursor:

Ferric sulfate was added into the niobium diselenide suspension prepared in step S1, so that a molar ratio of ferric sulfate to niobium diselenide was 1:0.15. The resulting mixture was stirred for dissolution, and added with ammonium phosphate while stirring so that a molar ratio of phosphorus:iron=1.6:1. The mixture was controlled at a pH of 2.0 (pH was adjusted with sodium hydroxide or hydrochloric acid), and heated up to 80° C. to react for 2 h to synthesize the iron phosphate in situ. The obtained product was subjected to solid-liquid separation to obtain the modified iron phosphate precursor; and

### S3. Preparation of Modified Lithium Iron Phosphate:

In a nitrogen atmosphere, the modified iron phosphate precursor of step S2, lithium carbonate and sucrose were mixed, so that a molar ratio of the modified iron phosphate precursor, to lithium carbonate and to sucrose was 1:1.2:0.3. The resulting mixture was sintered at 650° C. for 6 h to obtain the modified lithium iron phosphate.

### Comparative Example 1: (Compared with Example 3, No Niobium Diselenide was Doped)

In the present comparative example, a modified lithium iron phosphate was provided, and a method for preparing the modified lithium iron phosphate comprised the following steps:

### S1. Preparation of an Aqueous Solution of Polyvinylpyrrolidone:

A deionized aqueous solution of polyvinylpyrrolidone with a concentration of 1 wt % was prepared, which was stirred at 150 rpm for 12 min, and then ultrasonically dispersed at 16 KHz for 15 min;

### S2. Preparation of an Iron Phosphate Precursor:

Ferric sulfate was added into the aqueous solution of polyvinylpyrrolidone of step S1, and the resulting mixture was stirred for dissolution, and added with ammonium phosphate while stirring, so that a molar ratio of phosphorus:iron=1.6:1. The mixture was controlled at a pH of 2.0 (pH was adjusted with sodium hydroxide or hydrochloric acid), and heated up to 80° C. to react for 2 h, to synthesize the iron phosphate in situ. The obtained product was subjected to solid-liquid separation to obtain the iron phosphate precursor; and

### S3. Preparation of Lithium Iron Phosphate:

In a nitrogen atmosphere, the iron phosphate precursor of step S1, lithium carbonate and sucrose were mixed, so that a molar ratio of the iron phosphate precursor, to lithium carbonate and to sucrose was 1:1.2:0.3. The resulting mixture was sintered at 650° C. for 6 h to obtain the lithium iron phosphate.

### Comparative Example 2: (it Differed from Example 3 in that the Method of Doping Niobium Diselenide was Different, and Doping was Performed in the Sintering Stage)

In the present comparative example, a modified lithium iron phosphate was provided, and a method for preparing the modified lithium iron phosphate comprised the following steps:

### S1. Preparation of an Aqueous Solution of Polyvinylpyrrolidone:

A deionized aqueous solution of polyvinylpyrrolidone with a concentration of 1 wt % was prepared, which was stirred at 150 rpm for 12 min, and then ultrasonically dispersed at 16 KHz for 15 min;

### S2. Preparation of an Iron Phosphate Precursor:

Ferric sulfate was added into the aqueous solution of polyvinylpyrrolidone of step S1, and the resulting mixture was stirred for dissolution, and added with ammonium phosphate while stirring, so that a molar ratio of phosphorus:iron=1.6:1. The mixture was controlled at a pH of 2.0 (pH was adjusted with sodium hydroxide or hydrochloric acid), and heated up to 80° C. to react for 2 h, to synthesize the iron phosphate in situ. The obtained product was subjected to solid-liquid separation to obtain the iron phosphate precursor; and

### S3. Preparation of Modified Lithium Iron Phosphate:

In a nitrogen atmosphere, the iron phosphate precursor of step S1, niobium diselenide, lithium carbonate and sucrose were mixed, so that a molar ratio of the iron phosphate precursor, to lithium carbonate and to sucrose was 1:1.2:0.3, wherein the addition amount of niobium diselenide was the same as that in Example 3. The resulting mixture was sintered at 650° C. for 6 h to obtain the modified lithium iron phosphate.

### Test Example

The modified lithium iron phosphate or the lithium iron phosphate obtained in each of Examples 1-4 and Comparative Examples 1-2 as a cathode material, acetylene black as a conductive agent, and PVDF as a binding agent were mixed in a mass ratio of 8:1:1, and a certain amount of organic solvent NMP was added. The resulting mixture was stirred to obtain an electrode slurry. The obtained electrode slurry was coated on aluminum foil, and dried to make a cathode sheet, and the anode was a metal lithium sheet; the diaphragm was Celgard2400 polypropylene porous membrane; the solvent in the electrolyte was a solution composed of EC, DMC and EMC in a mass ratio of 1:1:1, and the solute was LiPF₆ with a concentration of 1.0 mol/L; a 2023 type button battery was assembled in a glove box. The resistivity of the prepared cathode sheet was tested by a four-point resistivity tester, and the initial efficiency test was performed on the battery. The capacity retention rate after 100 cycles at 0.2 C was tested within the cut-off voltage range of 2.2-4.3 V. The test results were shown in Table 1:

TABLE 1
Performance test results:

| | Resistivity of the | Capacity | Initial |
|---|---|---|---|
| Group | cathode sheet, Ω · m | retention, % | efficiency, % |
| Example 1 | 153 | 92.9 | 95.68 |
| Example 2 | 141 | 93.2 | 97.03 |
| Example 3 | 147 | 93.0 | 96.15 |
| Example 4 | 186 | 92.5 | 93.19 |
| Comparative | 392 | 90.3 | 89.22 |
| example 1 | | | |
| Comparative | 230 | 85.7 | 92.40 |
| example 2 | | | |

Analysis of the results: it can be seen from Table 1 that the modified lithium iron phosphate of the present disclosure has relatively good electrical conductivity, capacity retention rate and initial efficiency. The resistivity of the cathode sheet is 186 Ω·m or less, the capacity retention rate after 100 cycles at 0.2 C is 92.5% or more, and the initial efficiency is 93.19% or more.

Comparing Example 3 with Comparative example 1, it can be seen that with regard to the cathode sheet made of the modified lithium iron phosphate cathode material prepared in Example 3, the resistivity is significantly reduced, the conductivity is effectively improved, and the capacity retention rate and the initial efficiency are also improved. It is indicated that the method of the present disclosure modifies the precursor of lithium iron phosphate cathode material by doping niobium diselenide in the precursor, and then the cathode material is prepared by using the modified iron phosphate precursor, which can effectively improve the conductivity of the cathode material while ensuring that the cathode material has better structural stability, and meanwhile, the cathode material can be pre-supplemented with lithium to improve the initial efficiency. Comparing Example 3 with Comparative example 2, it can be seen that in Comparative example 2, as niobium diselenide is doped in the sintering stage of the cathode material, the doping effect is poor, resulting in a decrease in the conductivity, capacity retention rate and initial efficiency of the cathode material. Comparing Example 3 with Example 4, it can be seen that using the aqueous solution of polyvinylpyrrolidone to disperse niobium diselenide can bring better doping effect, and can further improve the conductivity, capacity retention rate and initial efficiency of the cathode material.

The above-mentioned examples are preferred embodiments of the present disclosure, but the embodiments of the present disclosure are not limited by the above-mentioned examples, and any other changes, modifications, substitutions, combinations and simplifications made without departing from the spirit and principle of the present disclosure should all be equivalent replacement manners, which are all included in the protection scope of the present disclosure.

1. A modified iron phosphate precursor, wherein the modified iron phosphate precursor is prepared by dissolving a soluble ferric salt in a niobium diselenide suspension and reacting a resulting mixture with a phosphoric acid source.

2. The modified iron phosphate precursor according to claim 1, wherein in the modified iron phosphate precursor, a molar ratio of the soluble ferric salt to niobium diselenide is 1:0.05-0.15, preferably 1:0.1-0.15;
a molar ratio of phosphorus element in the phosphoric acid source to iron element in the soluble ferric salt is 1.4-1.6:1, preferably 1.5-1.6:1.

3. The modified iron phosphate precursor according to claim 1, wherein the niobium diselenide suspension is prepared by dispersing niobium diselenide in a dispersion liquid.

4. The modified iron phosphate precursor according to claim 1, wherein the soluble ferric salt is at least one of ferric sulfate and ferric nitrate; and the phosphoric acid source is at least one of phosphoric acid and ammonium phosphate.

5. A modified lithium iron phosphate, wherein the modified lithium iron phosphate comprises a lithium source and the modified iron phosphate precursor according to claim 1.

6. The modified lithium iron phosphate according to claim 5, wherein the lithium source is lithium carbonate, lithium hydroxide, lithium acetate or lithium bromide; preferably lithium hydroxide or lithium carbonate.

7. A method for preparing the modified lithium iron phosphate according to claim 5, wherein the method comprises the following steps:
mixing a lithium source, a carbon source and the modified iron phosphate precursor in a protective atmosphere, and sintering a resulting mixture to obtain the modified lithium iron phosphate.

8. The method according to claim 7, wherein a molar ratio of the modified iron phosphate precursor, to the lithium source and to the carbon source is 1:1.1-1.2:0.1-0.3; preferably 1:1.1-1.2:0.2-0.3.

9. The method according to claim 7, wherein the carbon source is at least one of glucose, lactose and sucrose;
a temperature for sintering is 550-650° C., preferably 600-650° C.; and the sintering is conducted for 6-8 h, preferably 6-7 h.

10. A lithium battery, wherein the lithium battery comprises the modified lithium iron phosphate according to claim 5.

11. A modified lithium iron phosphate, wherein the modified lithium iron phosphate comprises a lithium source and the modified iron phosphate precursor according to claim 2.

12. A modified lithium iron phosphate, wherein the modified lithium iron phosphate comprises a lithium source and the modified iron phosphate precursor according to claim 3.

13. A modified lithium iron phosphate, wherein the modified lithium iron phosphate comprises a lithium source and the modified iron phosphate precursor according to claim 4.

14. The modified lithium iron phosphate according to claim 11, wherein the lithium source is lithium carbonate, lithium hydroxide, lithium acetate or lithium bromide; preferably lithium hydroxide or lithium carbonate.

15. The modified lithium iron phosphate according to claim 12, wherein the lithium source is lithium carbonate, lithium hydroxide, lithium acetate or lithium bromide; preferably lithium hydroxide or lithium carbonate.

16. The modified lithium iron phosphate according to claim 13, wherein the lithium source is lithium carbonate, lithium hydroxide, lithium acetate or lithium bromide; preferably lithium hydroxide or lithium carbonate.

17. A method for preparing the modified lithium iron phosphate according to claim 6, wherein the method comprises the following steps:
mixing a lithium source, a carbon source and the modified iron phosphate precursor in a protective atmosphere, and sintering a resulting mixture to obtain the modified lithium iron phosphate.

18. The method according to claim 17, wherein a molar ratio of the modified iron phosphate precursor, to the lithium source and to the carbon source is 1:1.1-1.2:0.1-0.3; preferably 1:1.1-1.2:0.2-0.3.

19. The method according to claim 8, wherein the carbon source is at least one of glucose, lactose and sucrose;
a temperature for sintering is 550-650° C., preferably 600-650° C.; and the sintering is conducted for 6-8 h, preferably 6-7 h.

20. A lithium battery, wherein the lithium battery comprises the modified lithium iron phosphate according to claim 6.
